(19) United States
(12) Patent Application Publication
(10) Pub. No.: US 2008/0189309 A1
(43) Pub. Date: Aug. 7, 2008

(54) DATA WRITING SYSTEM AND METHOD FOR MULTI-TYPE AIR CONDITIONING SYSTEM

(75) Inventors: Jong-Hyun HAN, Seoul (KR); Sang-Chul YOUN, Seoul (KR); Duck-Gu JEON, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 12/018,366

(22) Filed: Jan. 23, 2008

(30) Foreign Application Priority Data
Feb. 1, 2007 (KR) 10-2007-0010788

(51) Int. Cl. G06F 17/30

(52) U.S. Cl. 707/100; 707/E17.001

(57) ABSTRACT

A data writing system and method for a multi-type air conditioning system according to the present invention associates data related to each system device (for data that was otherwise independently maintained) and performs management thereof, while allowing the deletion of any redundant data, and writes data to form a hierarchical structure through reference, thereby enhancing service inquiry and service usage performance.

### BACKGROUND OF THE INVENTION

1. Field of the Invention

The present invention relates to a multi-type air conditioning system and a data writing system and method therefor, and more particularly, to a multi-type air conditioning system and data writing system and method therefor which allows system management by generating data for each system device upon conforming the valid association thereof.

2. Description of the Background Art

With a recent increase in the use of air conditioning systems, air conditioning systems are now used in most buildings and homes. As one type of air conditioning system, so-called “multi-type air conditioners” include indoor units disposed in each room of a home or in each office in an office building, and an outdoor unit shared by and connected to the indoor units.

Hereinafter, a multi-type air conditioning system is referred to as a system comprised of a plurality of multi-type air conditioners.

The multi-type air conditioning system includes a local controller which detects the operation status of the plurality of multi-type air conditioners and, according to the detection, controls the plurality of air conditioners via a gateway.

In the multi-type air conditioning system, setting information and status information related to each of a gateway, an outdoor unit and an indoor unit are written into a table, and as shown in FIG. 1, this data is composed as an independent table according to each device.

That is, as shown in FIG. 1, each device is distinguished from each other via an identifier for each of the gateway, the outdoor unit ODU and the indoor unit IDU. And, a gateway identifier is included in the outdoor unit's table, showing the top and bottom relationship of a hierarchy.

Here, each of the identifiers is required information. However, there is a need to manage an application that stores such data so as to maintain its consistency, considering that the identifiers can be redundant since there is no restriction on the value of the identifiers and that an identifier of an upper hierarchy which does not exist can be included.

However, as described above, if redundant setting information and status information related to the multi-type air conditioners exists, a problem regarding the stored data may be found, but it is difficult to resolve such error, and the like.

Further, since no association between such data is specified, data searching and addition/deletion need to be performed according to a method defined by a local controller using the data. Since redundant data may be used when data is added, such data together with data of a non-existing device may remain in a table, thereby not guaranteeing the data integrity.

### SUMMARY OF THE INVENTION

Therefore, in order to solve those problems of the related art, it is an object of the present invention to provide a multi-type air conditioning system and a data writing method thereof which can enhance service inquiry and service usage performance by associating data related to each device (for data that was otherwise independently maintained) and performing management thereof, while allowing the deletion of any redundant data, and writing data to form a hierarchical structure through reference checking.

To achieve these and other objects and advantages and in accordance with the purpose of the present invention, as embodied and broadly described herein, in a multi-type air conditioning system having one or more multi-type air conditioner groups each provided with a local controller connected to a plurality of multi-type air conditioners via a gateway, and configured to tabulate setting information and status information related to each of the one or more multi-type air conditioner groups as a table, there is provided a data writing system for the multi-type air conditioning system, comprising: a data writing unit configured to write the setting information and status information by tabulating a hierarchical relationship between devices through reference checking; and a database configured to store a gateway information table, an outdoor unit information table, an indoor unit information table, indoor unit/outdoor unit status tables, and a data table for various contents.

Here, when data is to be added, the data writing unit is configured to abstract an identifier from the corresponding data and to block data addition by a violation of a foreign key restriction if the corresponding data is determined to be unreferenced data by performing a check using the abstracted identifier. When data is to be added, the data writing unit is configured to abstract an identifier from the corresponding data and to add the corresponding data if the corresponding data is determined not to be redundant data and also determined to be referenced data by using the abstracted identifier. When data is to be deleted, the data writing unit is configured to delete the corresponding data together with any data referring to the corresponding data.

To achieve these and other advantages and in accordance with the purpose of the present invention, as embodied and broadly described herein, there is also provided a data writing method for a multi-type air conditioning system including a step of writing setting information and status information related to each of one or more multi-type air conditioner groups as a table, comprising: writing the setting information and status information by tabulating a hierarchical relationship between system devices through checking their reference, and storing the written data in a table.

Here, the step of writing data by tabulating a hierarchical relationship between the system devices through reference checking comprises: writing setting information and status information related to an outdoor unit by specifying a primary key of a gateway table as a foreign key; writing setting information and status information related to each indoor unit by specifying a primary key of the setting information and status information related to the outdoor unit as a foreign key; and writing setting information and status information related to each indoor unit for monitoring and other information of multi-type of air conditioners by specifying a primary key of the setting information and status information related to each indoor unit as a foreign key.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram schematically illustrating a data structure for a related art multi-type air conditioning system;

FIG. 2 is a schematic block diagram illustrating the organization of a multi-type air conditioning system to which the data writing system and method according to the present invention are applied;

FIG. 3 is a diagram schematically illustrating a data structure for the multi-type air conditioning system according to the present invention;

FIG. 4 is a flowchart illustrating an operation when data is added in the multi-type air conditioning system of FIG. 2;

FIG. 5 is a flowchart illustrating an operation when data is deleted in the multi-type air conditioning system of FIG. 2; and

FIG. 6 is a diagram schematically illustrating a data structure integrating the plurality of multi-type air conditioning systems in FIG. 2.

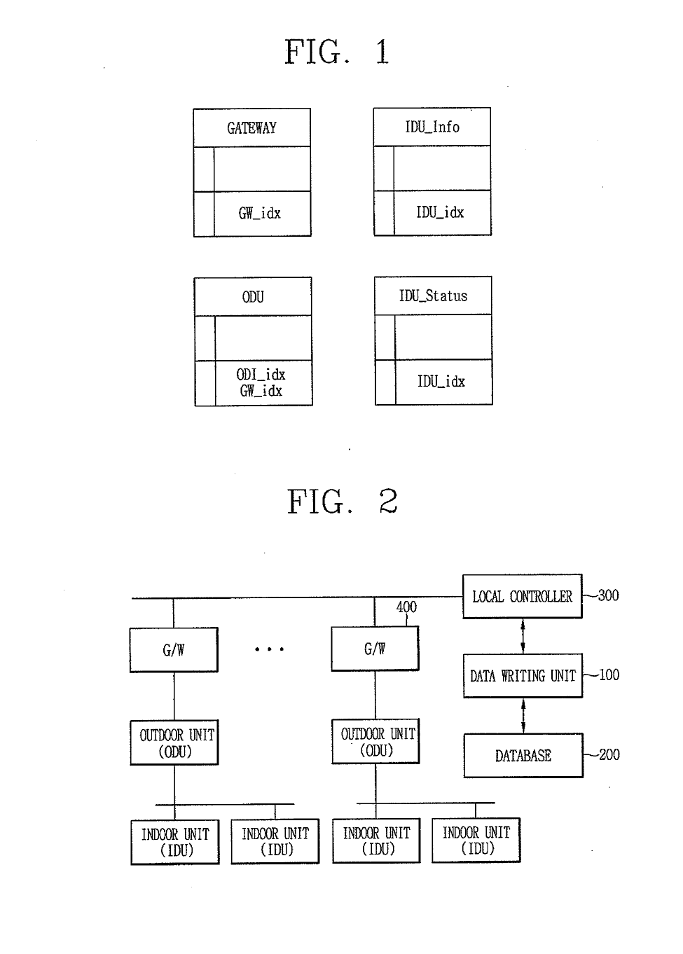

### DETAILED DESCRIPTION OF THE INVENTION

Description will now be given in detail to the preferred embodiments of the present invention, examples of which are illustrated in the accompanying drawings.

FIG. 2 is a block diagram illustrating the organization of a multi-type air conditioning system to which the data writing system and method according to the present invention are applied.

As shown in FIG. 2, there are provided a data writing unit 100, a database 200, a local controller 300, a gateway 400, a plurality of outdoor units ODU and indoor units IDU.

The data writing unit 100 writes setting information and status information related to each device by tabulating a hierarchical relationship between the devices using reference checking.

Here, when data is to be added, the data writing unit 100 abstracts an identifier from the corresponding data, and by using the abstracted identifier, blocks data addition by a violation of a foreign key restriction in case the corresponding data is determined to be unreferenced data, and adds the corresponding data if by using the abstracted identifier the corresponding data is determined not to be redundant data and is also determined to be a referenced data. When data is to be deleted, the data writing unit 100 deletes the corresponding data together with any data referring to the corresponding data.

The database 200 stores a gateway information table, an outdoor unit information table, an indoor unit information table(s), indoor/outdoor status tables, and a data table for various informational contents concerning the system.

The local controller 300 is connected to a plurality of outdoor and indoor units through the gateways, and serves to control the outdoor and indoor units and to perform monitoring thereof.

Each gateway 400 is connected to an outdoor unit at a lower hierarchical level thereto and to the local controller 300 at an upper hierarchical level thereto, and serves to transmit control commands of the local controller 300 to the lower level outdoor/indoor units and to transmit control results or status monitoring data to the local controller.

And, the plurality of outdoor and indoor units perform the commands of the local controller 300 and the monitoring, and are connected to the gateway 400 at an upper level thereto.

The operation of the system and method according to the present invention will be described in detail with reference to the accompanying drawings.

First, the database 200 implemented according to the present invention stores the gateway information table, the outdoor unit information table, the indoor unit information tables, the indoor/outdoor status tables, and the data table for various informational contents.

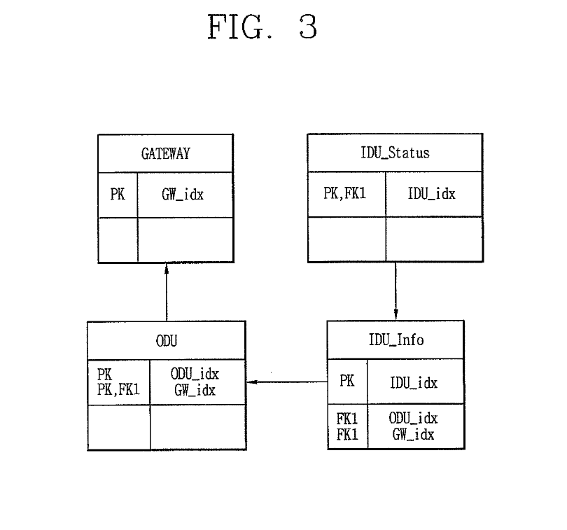

Here, according to the present invention, as shown in FIG. 3, in order to express data having a hierarchical association as relational data, an identifier of an upper entity and a primary key are included in the data, thereby specifying the data as a foreign key.

In such state, the local controller 300 generates control data to control the plurality of outdoor/indoor units based on status information and setting information received from the gateway 400 related to the plurality of outdoor/indoor units, and then transmits the generated control data to the corresponding outdoor/indoor units through the gateway.

Here, the data writing unit 100 writes status information and setting information data received in the local controller 300 by tabulating the hierarchical relationships between the devices through reference, and thus, the written data is stored in corresponding tables of the database 200.

In addition, the data writing unit 100 writes the control data generated in the local controller 300 by tabulating the hierarchical relationships between the devices through reference, and then supplies the written data to the local controller 300.

Accordingly, the local controller 300 transmits the control data to the corresponding indoor and outdoor units via the corresponding gateway 400.

Here, the data writing operation of the data writing unit 100 will now be given in detail.

First, the data writing unit 100 specifies a primary key of the gateway table as a foreign key to setting information and status information related to the outdoor unit ODU, and specifies a primary key of the setting information and status information related to the outdoor unit ODU as a foreign key to setting information and status information related to the indoor unit IDU, and also specifies a primary key of the setting information and status information related to the indoor unit IDU as a foreign key to setting information and status information related to the indoor unit IDU for monitoring and other informational contents of each multi-type air conditioner. The primary key and foreign key are expressed as an index.

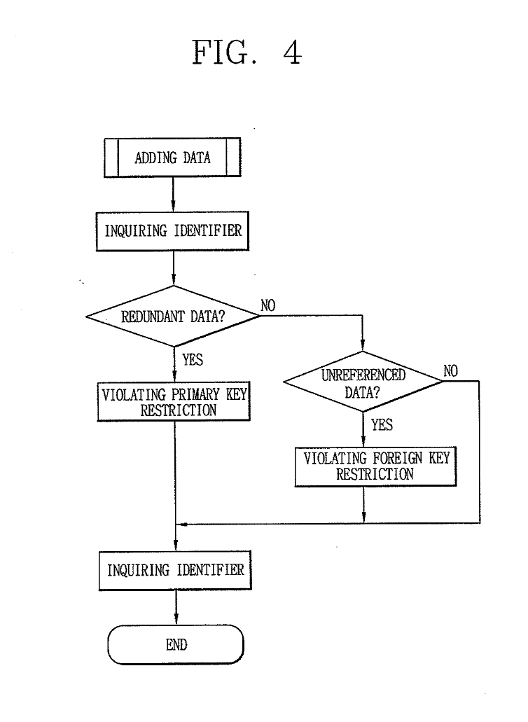

Description of an operation when the data writing unit 100 adds data will be given with reference to FIG. 4.

First, an identifier of the corresponding data is abstracted, and if the corresponding data is determined by using the abstracted identifier to be redundant data, data addition is blocked by a violation of a primary key restriction. In addition, if the corresponding data is determined by using the abstracted identifier to be unreferenced data, data addition is blocked by a violation of a foreign key restriction. Further, if the corresponding data is determined by using the abstracted identifier to be a referenced data, and not to be a redundant data, then the corresponding data is added into the relevant table.

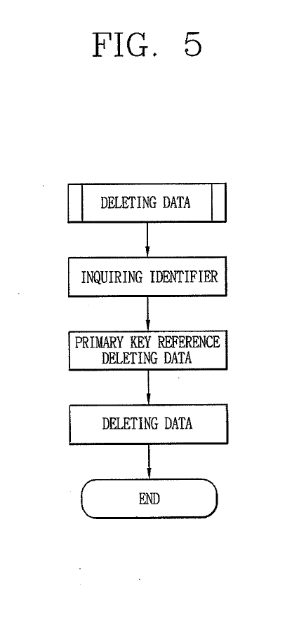

Description of an operation when the data writing unit 100 deletes data will next be given with reference to FIG. 5.

First, in a data deletion mode, an identifier of the corresponding data to be deleted is abstracted, and by using the abstracted identifier the corresponding data together with any data referring to the corresponding data is deleted.

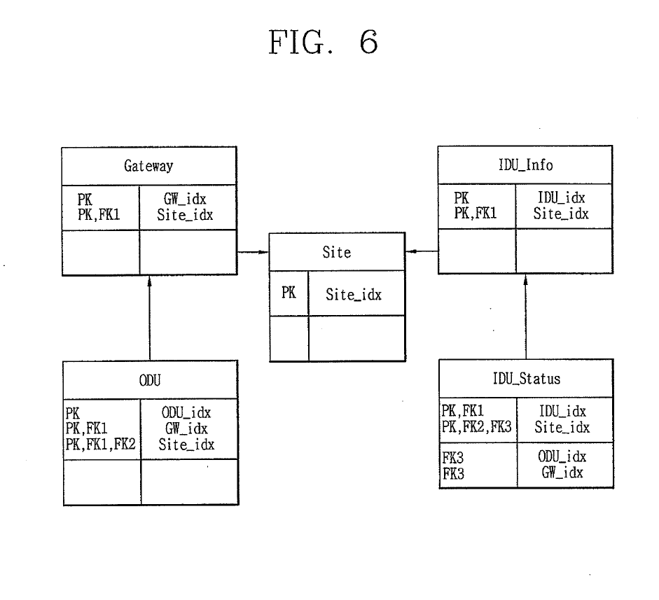

FIG. 6 is a schematic view illustrating the data writing method when data of a plurality of multi-type air conditioning systems are integrated.

That is, if the data concerning a plurality of multi-type air conditioning systems is to be implemented as an integrated database, a system information table may be added into the database, and a foreign key may be added to data tables of each hierarchy.

FIG. 6 shows another embodiment of the data writing method for the multi-type air conditioning system according to the present invention. Using the hierarchical relationship between the primary key and the reference key, management can be possible by association of key values.

That is, a lower index is expressed by an upper index and a lower unit identifier. Here, hierarchical data is expressed together with an index key.

The above-mentioned method may express the hierarchical data without using a foreign key, but there is a need to manage for integrity.

The above-described data writing system and method for a multi-type air conditioning system according to the present invention can write data regarding setting information and status information for each device by tabulating the hierarchical relationship between devices using reference.

Here, the data writing method according to the present invention can be applied to each device to write data, by implementing the data writing unit in the plurality of indoor units IDU and outdoor units ODU, the gateway, and the like.

The data writing system and method for a multi-type air conditioning system according to the present invention can be applied to a system comprised of multi-type air conditioners and single-type air conditioners, as well as to a system comprised of only multi-type air conditioners.

The preferred embodiments of the present invention have been described in detail with reference to the drawings; however, they should not be construed as limiting the scope of the present invention. Also, it will be obvious to those skilled in the art that variations may be implemented within the scope as defined by the appended claims.

As described above, the data writing system and method for a multi-type air conditioning system according to the present invention associates data related to each system device (for data that was otherwise independently maintained) and performs management thereof, while allowing the deletion of any redundant data, and writes data to form a hierarchical structure through reference, thereby enhancing service inquiry and service usage performance.

The foregoing embodiments and advantages are merely exemplary and are not to be construed as limiting the present disclosure. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A data writing system for a multi-type air conditioning system having one or more multi-type air conditioner groups provided with a local controller connected to multi-type air conditioners via a gateway, and configured to format setting information and status information related to each of the one or more multi-type air conditioner groups as a table, comprising:
a data writing unit configured to write the setting information and status information by tabulating a hierarchical relationship between devices of the air conditioning system through reference; and
a database configured to store table information written by the data writing unit.

2. The system of claim 1, wherein the setting information and status information are specified as a primary key and a foreign key by including an identifier of a higher level entity.

3. The system of claim 2, wherein the data writing unit expresses the primary key and foreign key as an index.

4. The system of claim 1, wherein the table information includes a database which stores one or more of a gateway information table, an outdoor unit information table, an indoor unit information table, indoor/outdoor status tables, and a data table for various informational contents concerning the air conditioning system.

5. The system of claim 4, wherein the data writing unit specifies a primary key of the gateway information table as a foreign key for setting information and status information related to an outdoor unit of the multi-type air conditioning system.

6. The system of claim 5, wherein the data writing unit specifies a primary key of the setting information and status information related to the outdoor unit as a foreign key for setting information and status information related to an indoor unit of the multi-type air conditioning system.

7. The system of claim 6, wherein the data writing unit specifies a primary key of the setting information and status information related to the indoor unit as a foreign key for setting information and status information related to the indoor unit for monitoring and other informational contents of the multi-type air conditioning system.

8. The system of claim 1, wherein when data is to be added, the data writing unit abstracts an identifier from corresponding data, and by using the abstracted identifier, blocks data addition by a violation of a primary key restriction if the corresponding data is determined to be redundant data.

9. The system of claim 1, wherein when data is to be added, the data writing unit abstracts an identifier from corresponding data, and by using the abstracted identifier, blocks data addition by a violation of a foreign key restriction if the corresponding data is determined to be unreferenced data.

10. The system of claim 1, wherein when data is to be added, the data writing unit abstracts an identifier from corresponding data and adds the corresponding data if the corresponding data is determined by using the abstracted identifier to be referenced data, and not redundant data.

11. The system of claim 1, wherein when data is to be deleted, the data writing unit deletes corresponding data together with any data referring to the corresponding data.

12. A data writing method for a multi-type air conditioning system wherein setting information and status information related to each of one or more multi-type air conditioner groups is contained in a table, comprising:
writing the setting information and status information by tabulating a hierarchical relationship between devices of the multi-type air conditioning system through reference; and
storing the written data in the table.

13. The data writing method of claim 12, wherein writing data comprises:
writing the setting information and status information by specifying a primary key and an identifier of a higher level entity as a foreign key.

14. The data writing method of claim 12, wherein writing data comprises:
writing setting information and status information related to an outdoor unit by specifying a primary key of a gateway table as a foreign key;
writing setting information and status information related to an indoor unit by specifying a primary key of the setting information and status information related to the outdoor unit as a foreign key; and
writing setting information and status information related to the indoor unit for monitoring and other informational contents of the multi-type air conditioning system by specifying a primary key of the setting information and status information related to the indoor unit as a foreign key.

15. The data writing method of claim 12, wherein when data is to be added, an identifier of corresponding data is abstracted, and if the corresponding data is determined by using the abstracted identifier to be redundant data, data addition is blocked by a violation of a primary key restriction.

16. The data writing method of claim 12, wherein when data is to be added, an identifier of corresponding data is abstracted, and if the corresponding data is determined by using the abstracted identifier to be unreferenced data, data addition is blocked by a violation of a foreign key restriction.

17. The data writing method of claim 12, wherein when data is to be added, an identifier of the corresponding data is abstracted, and if the corresponding data is determined by using the abstracted identifier to be referenced data, and not redundant data, the corresponding data is added.

18. The data writing method of claim 12, wherein when data is to be deleted, corresponding data is deleted together with any data referring to the corresponding data.
